(19) United States
(12) Patent Application Publication
(10) Pub. No.: US 2014/0077520 A1
(43) Pub. Date: Mar. 20, 2014

(54) SUN SCREEN

(71) Applicant: MARCIA A. MCMANUS, POMPANO BEACH, FL (US)

(72) Inventor: MARCIA A. MCMANUS, POMPANO BEACH, FL (US)

(21) Appl. No.: 13/848,713

(22) Filed: Mar. 21, 2013

Related U.S. Application Data
(60) Provisional application No. 61/614,483, filed on Mar. 22, 2012.
(60) Provisional application No. 61/616,411, filed on Mar. 27, 2012.

(51) Int. Cl. B60J 3/02; B64D 11/00

(52) U.S. Cl. CPC B60J 3/0278; B64D 11/0023
USPC 296/97.3

(57) ABSTRACT

The present invention relates to an apparatus, method and system for protecting the occupants of vehicles and aircraft from sun glare.

### CROSS REFERENCE TO RELATED APPLICATIONS

This non-provisional utility application claims priority from U.S. Provisional Application No. 61/614,483 filed on Mar. 22, 2012, and U.S. Provisional Application No. 61/616,411 filed on Mar. 27, 2012.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

### Vehicle Sun Screen

There are several types of Car Sun Shades to block sun from the kids in the back seat from left or right or back side ONLY while driving.
A. There is no sun shade currently on the market to block the sun from the FRONT while driving or
B. From the Passenger/Driver seat head rest to the back side window while driving or
C. There is no shape currently to cover back windows for 2 door vehicles that are not regular/normal shape (square/rectangular).
D. The screen can either be affixed or portable to the driver and or passenger head rest or any part of seat structure, attach to floor, car roof or side panels inside the car but not limited to.
E. The structure to hold the screen can either be affixed with or without the screen for storage.
F. Static Cling is Prior Art. Updated Art will be a Static Cling that has a coat on the surface that can be written on with an erasable device including not limited to pens, markets, chalk etc. Material is not limited to Static Cling once is being used for this purpose in the car.
G. There is no sun shade on the market offering the consumer to personalize a message on the sun screen daily if needed. Message can be school related trying to solve Math Problems, Learning words or ABC's or Numbers, or what ever stage the child is at in his learning
H. Unique product package. The double sided card (Cover) attachment has product on one side and gift card label on other side. When product label is flip over it converts to a gift box. This allows the consumer one stop shopping and convenience with out buying additional gift paper, tags and bags.
I. Vehicle Solar Sun Screen fabric convert s mesh to solar energy for Power supply. Using inverter and prongs to retrieve the energy stored in mesh to power ipod etc with the connectors. This is not limited to vehicles it can be used in other locations.

This patent resolves some main issues previously not addressed in the current sun shades on the market. It reduces the sun rays that enters the car from the front. It also reduces the rays between the passenger or driver side head rest and the back side windows. This will makes the back seat passenger more comfortable. The consumer has the option to buy the screen from the vehicle manufacture as an optional or standard feature or from a retailer as an addition feature to the vehicle.

The customer has the option to personalize a message on the screen for the back seat passenger depending on the level and age group This can be used as an additional learning tool while on a drive and some versions can also be portable to take out of the vehicle after the drive. This makes learning fun and easy in an unconventional way.

Before this package the consumer had to buy other gift accessories to cover the product box. It is less expensive for the consumer and less trash to throw away for the environment.

### Portable or Inexpensive Affixed Vehicle Semi Privacy Screen

There is currently no Portable or Inexpensive Affixed Semi or Private Vehicle Screen on the market designed for the back seat passenger. This screen can be used during the day or night
A. The screen is used to divide the space between the driver and passenger seat from the back seat passenger
B. This offers the back seat passenger partial or full visual privacy from the front seat passengers.
C. Very economic option for privacy compared to a Limo or Taxi fixed glass or curtain divider

### Portable or Pop Up, Affixed Work Station Divider/Semi Privacy Screen

The portable or Affixed Screen can be converted to a desk top Semi Privacy screen.
A. This is a less expensive solution and alternative for privacy in the office compared to floor model privacy screens or cubicles
B. It can adjust to several heights or widths.
C. Flexible structure
D. Various shapes and designs

### Portable Child Play Station Divider/Semi Privacy Screen

A. The screen can be used to define the space. The child and activities are still visible over and through the screen.
B. The screen can be used on the desk or floor.

### Optional Designs on or of Screen

### (Portable Educational or Fun, Decorative, Unique, Custom Screens)

TV in car seat are very expensive and not affordable, fun screen is a cheaper alternative. The current screen shape are generic. The screen is used as a screen only in other designs and can not convert into other use or fun screen.
A. These designs on screen can be educational to help the child develop reading and association skills while sitting.
B. Colorful, glow in dark paint/material, fun shapes, lights, LED, Fiber Optic, electroluminescent technology, animation, luminous ink, luminescent pigment/ink/power
C. Attach other educational products to the screen for a variety.
D. Make use of wasted space in car while being used as a Sun Screen, Privacy Screen or just for fun/educational.
E. Design or customize your own screen by adding paint, cut out applications direct on screen, etc
F. Digital printing customization. This allows the customer to get any image, any design, in any quantity with unlimited ink colors, with no set up fee and no minimum purchase to order. Very economical and inexpensive. Before customers had to pay set up fee for Screen
G. Customer has the option to personalize any message daily for their back seat passenger and make it fun and educational

### Airplane/Transportation Screen

A. This is a portable screen used to block some of the sun entering the airplane including but not limited to the passengers seats windows.
B. The other shapes can be used to as a semi privacy screen to block view of another passenger sitting directly next to or opposite. This can be portable or affixed to any part of structure including but not limited to the seat hand rest or on seat sides.
C. The larger design screen can be used for airplane or other vehicles on the windshield.
D. Currently there is no portable privacy screen or window shades designed for airplane use for passenger.
E. Screens/Dividers can also be Affixed to passengers seats, on or between but not limited to.

### Screens/Bulbs

All screen shapes, designs, function, purpose as described and illustrated can be used for the purposes as designed but not limited to. Any designs and shapes can be customized to customer's request and used in vehicles, homes, offices, airplane, play area, boat, schools but not limited to. The screens can be used for several functions including blocking sun, dividers, educational but not limited to. The drawings and descriptions are examples and not the only designs or shapes or purpose and function for this product. This patent is also for all present and future screens attached to the drivers and or passengers seats functioning as Sun Screen, Privacy Screen, Dividers. This patent is also for screens attached to the drivers or passengers side head rest connecting screen to back side windows. The use of suctions cups can be optional to change the function and purpose of screen.

All Front car screens can be attached between or at the back of the passenger and driver seats. It can also be attached from the side panel structure and or door next to the driver and passenger side vehicle structure or inside roof. Can also be retractable and manual to be in seat to hide from view.

Some Screens can be used as but not limited to Privacy/Semi Privacy and or Sun Screen depending on the material used for the construction.

The patent is also for over head black light bulb in side the vehicles.

Patent is also for the use of paints, logos, designs, technology etc used on the screen functioning as Sun Screen, Semi Privacy screen, Dividers but not limited to.

### Package

This package offer several options to the consumer which reduces clutter, visually appealing and offer storage and optional compartments. This compact package allows the consumer to keep the screen in a discreet location in the car until ready for use.

Currently most shades are designed to either be affixed on window, roll up and affixed directly to window even if there is no passenger in the back seat. It's may be too cumbersome to store in the car.

### Other Package Design & Display Unit

Package design concept converts product box into a gift box. Or box into another design does not have to be a gift tag. Same concept can be used to convert other things eg like bags into a different design. The back can become the front and vice versa

There are several ways to do the conversion to a gift box and the drawings are for illustration purposes. The attachment can be made in several ways by sliding the card top to bottom, side to side or attached to side and move from front to back, swivel but not limited to. Depending on the application card can either be double sided or single sided or swivel design. You can also use magnets, hooks, straps but not limited to attaching the label or cover to convert box to any design.

Display unit will be similar to FIG. 51 with opening in front to put items in for display.

### Black Light Technology

Currently there is no Black light technology bulb to switch in vehicles for the overhead bulbs or in the side vehicle doors.
A. When this idea is developed it will be a less expensive way to change the color in the vehicles today instead of using regular portable converters or cigarette lighter converters.
B. It will be more efficient and less bulky
C. Safer since it will be more secure in the vehicle.

### Solar Sun Screen Mesh/Power Supply

This will require the electron with prongs to connect into inverter to release the solar energy stored in the mesh to provide additional power for eg ipods

### SUMMARY OF INVENTION

### Vehicle Sun Shade

1. Sun Shade to block the sun from the FRONT for passengers comfort in the back seat while driving directly towards the sun.
2. The Sun Shade can also be used to block sun from the Driver or Passenger side head rest to the back seat window of the car. This is additional coverage from FRONT to BACK. Current Sun Shade designs only block sun from the back window only.
3. The design can be used on all types of vehicle back windows including 2 door car windows. Currently there is no design shade for 2 door back window.
4. Because of the various sizes, dimensions and styles and customized options and design the Screens can used on Side windows, back windows, wind shields and Front screen between or behind drivers and passengers seats.
5. The Erasable surface sun screen is an educational tool so the back seat passenger can continue to learn while in the car
6. Any screen attached does not only have to be used to prevent the sun glare for the back seat passenger it can also be used as an Education tool or any other use the consumer see fit providing its safe.
7. Screens can be converted to be used in several places of the car for example but not lifted to the front car screen can be converted to also use on the rear window and or back side window or vice versa

### Portable or Inexpensive Affixed Semi Privacy Screen

1. Can be used to separate the front seat driver/passenger from the back seat passengers.
2. Used as an Education tool with predetermine message or personalized daily by the consumer depending on the version bought

### Portable or Pop Up, Affixed Work Station Divider/Semi Privacy Screen

1. Economical desk space separation.
2. Separate workstations, have a flexible structure, various shapes and design

### Portable Child Play Station Divider/Semi Privacy Screen

Used to separate or group kids together.

### Optional Designs on or of Screen

### (Portable Educational or Fun, Decorative, Custom and Unique Screen)

1. Making use of wasted space in car by using fun or education products on the screen
2. Or fun/educational items while in use as a Sun Screen or Privacy Screen

### Package

1. Compact and easy storage for screen when not in use.
2. Optional Compartments
3. Converts product box into a gift box

### Black Light Bulb to Substitute in Vehicle Over Hear Light and Side Doors. (Summary)

The black bulb for the interior lights above the head and side doors have not been invented as yet for vehicles

### Airplane Screens

The economical screen will be in several sizes and shapes depending on the function (sun screen, dividers, windshield coverage) but not limited to. The design is portable and offers the consumer flexibility to use the product as seen fit.
1. The screen is used to block sun from the side window for the passengers.
2. It gives the passenger the option to block the sun and still see out side. Currently if you block the sun by closing the window shade you cannot see the view outside. This will increase passenger comfort and visibility for the outside.
3. The passenger can also use the other shape as a divider between seats for semi privacy. This is an excellent option if the passenger at the window seat does not close the window and the sun it affecting the other passengers in the same row.
4. The screen can be used on the windshield of airplane on the ground or in car, trucks etc when parked and safe to use to block sun and keep the vehicle cooler

### Solar Sun Screen Mesh/Power Supply

This will allow the consumer to have additional power supply in the vehicle to charge items for eg ipods etc if additional outlets are needed. This screen device can also be portable and taken into parks etc to have additional power supply. The sun ray can be captured for additional power with the screen in the vehicle but not limited to be a fabric.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings:

FIG. 1

Front (view from Rear seat)
101 Adjustable strap to change the end shape of the screen for the windows that are not square or oblong or rectangular. (Optional for side window)
102 Extra Support for the shape
103 Sun Screen material
104 Regular support for the shape

FIG. 2

Back (View from the Driver/Passenger seat)
201 (CROSS Reference FIG. 1, 101) Adjustable strap to change the end shape of the screen for the windows that are not square or oblong or rectangular. (Optional for side window)
202 Adjustable screen support for the Driver's side seat rest
203 Adjustable screen support for the Passenger's side seat rest
204 Suction Cup (optional for side window)

FIG. 3

Packaging/Housing to store screen when not in use

Front (View from the Rear Seat)
301 Logo on the Package
302 Logo and product name

FIG. 4

Package Back View
401 Oblong Suction cup (Optional for side window)
402 Opening for shade to be inside the package
403 Adjustable strap passenger's side
404 Pocket for Optional Air Freshener/Scents for kids

FIG. 5
501 Optional material to attach screen to the inside of the package

FIG. 6

Front view of Package/housing attached
601 View of Screen when attached to the package

FIG. 7

Back view of Package/housing attached
701 Oblong suction Cup
702 Adjustable Strap Driver's side
703 Opening for the shade to be inside the package
704 Adjustable strap passenger's side
705 Pocket for Optional Air Freshener/Scents for kids

FIG. 8

Different layers of the package
801 (Cross reference 601) Top layer with logo Design
802 (Cross reference FIG. 4) Bottom of Package
803 Inside 2^{nd} layer
804 Inside 1^{st} layer (Optional for extra storage)

FIG. 9

Front view
901 Optional additional wider edge material for custom design space.

FIG. 10

Deluxe Screen . . . Fun Shapes (Front view)
1001 Vehicles

FIG. 11

Deluxe Screen . . . Fun Shapes (Front view)
1101 Animals

FIG. 12

Graphic Designs or attachments
1201 Graphic Designs customized or standard can be printed on Basic or Deluxe Sun Screen Shape.

Graphic not limited to Logos, license images, regular graphics, exclusive graphics.

Other accessories Paints, lights, Glow in Dark materials

FIG. 13

Optional Side Window Screen (inside view)
1301 Adjustable strap when used to change shape of the screen

The strap attached to the screen can be used to adjust the end of the screen to another shape if the car window is not rectangular or square.

FIG. 14

Optional Side Window screen (outside view)
1401 Cross Reference FIG. 2, 202 Adjustable strap
1402 Cross reference FIG. 13, 1301 Adjustable strap to change screen shape
1403 Cross reference FIG. 4, 402 Opening for shade to be inside the package
1404 Cross reference FIG. 4, 404 Pocket for Optional Air Freshener/Scents for kids
1405 Cross reference FIG. 4, 401 Oblong Suction cup (Optional for side window)

FIG. 15

Semi Privacy screen
1501 Basic shape.

A. For use in Vehicles

B. Desk or floor with stand converter for optional use for in the home, office, schools as mini dividers

C. Refer to FIG. 10, 1001 and FIG. 11, 1101 for other shapes (animals/vehicles)

FIG. 16

Semi Privacy screen

View can be adjustable within the screen
1601 Support structure for screen
1602 Clear view between front and back seat
1603 Obstructive view between front and back seat when the screen move down to another location on the frame.
1604 Screen can be attached with Velcro or any material to be adjustable at the top and sides

FIG. 17

Semi Privacy screen adjustments
1701 The screen can be folded or adjusted to several heights

FIG. 18

Semi Privacy screen

Optional confirm material for structure
1801 By adding pressure the screen can change shape because of confirm material used.

FIG. 19

Basic shape of the Semi Privacy Screen with surface support
1901 Basic screen
1902 Left Support to hold screen in place
1903 Right Support to hold screen in place

FIG. 20

2 Screens attached
2001 1^{st} Screen
2002 Screen 1 and 2 are temporally attached together
2003 Surface support
2004 Other surface support
2005 2^{nd} Screen

FIG. 21

Several screens can be connected in any direction
2101 1^{st} Screen (Cross Reference FIG. 20 2001)
2102 2^{nd} Screen
2103 3^{rd} Screen
2104 4^{th} Screen

FIG. 22

Deluxe shape Portable Semi Privacy Screen and surface support.
2201 Vehicle shape
2202 1^{st} Support
2203 2^{nd} Support

FIG. 23

Front view . . . Mix and Match Deluxe and Basic shapes Portable Semi Privacy Screen
2301 1^{st} Basic Screen Cross Reference Rig 20, 2001
2302 Vehicle shape Cross Reference FIG. 22
2303 2^{nd} Basic Screen

FIG. 24

Back view . . . Mix and Match Deluxe and Basic shapes Portable Semi Privacy Screen
2401 1^{st} Basic Screen Cross Reference Rig 20, 2001
2402 2^{nd} Basic Screen
2403 Surface support Cross Reference FIG. 22, 2202
2404 Vehicle shape Cross Reference FIG. 22
2405 Surface support Cross Reference FIG. 22, 2203

FIG. 25

Any Portable Semi Privacy screen can be attaché to the basic support or accessories holder support
2501 Accessories holder and surface support
2502 Basic surface support

FIG. 26

Accessories holder and surface support for Semi Privacy Screen
2601 Support for Accessories holder
2602 Accessories Container
2603 Bottom support

FIG. 27

Basic Surface Support
2701 Support groove to hold the screen in place

FIG. 28

2 Front Seats
2801 Driver Seat
2802 Passenger Seat

FIG. 29
2901 Optional Package holder attached to Passenger seat

FIG. 30

View of screen from the back seat in a vehicle
3001 Steering wheel in car
3002 Airplane design screen
3003 Windshield
3004 Attachment of Screen to Passenger head rest

FIG. 31

Black Light bulb substitution in over head or side doors fixture to produce black light in vehicle.
3101 Rear view mirror
3102 Roof inside the car
3103 Over head light bulbs changed to Black Light technology bulb to create black light to illuminate designs in vehicle or screen.
3104 Cross reference FIG. 30, 3004 Attachment of screen to passenger head rest.

FIG. 32

Front Side screens (Single Screen)
3201 Drivers side, Front Side Screen attached to head rest
3202 Windshield
3203 Passenger side, Front Side Screen attached to head rest
3204 Space between Passenger's seat and Passenger's door
3205 Space between Driver's seat and Driver's door

FIG. 33

Front Side screens, Double Screen (Mini)
3301 The screen can be folded back to look like a since screen in FIG. 32, 3201
3302 Refer to FIG. 32, 3203 Screen
3303 2^{nd} side screen is attached to make 3302 a Mini Front Double Screen
3304 Suction Cup to attach to back seat side window
3305 Refer to FIG. 32, 3204

FIG. 34

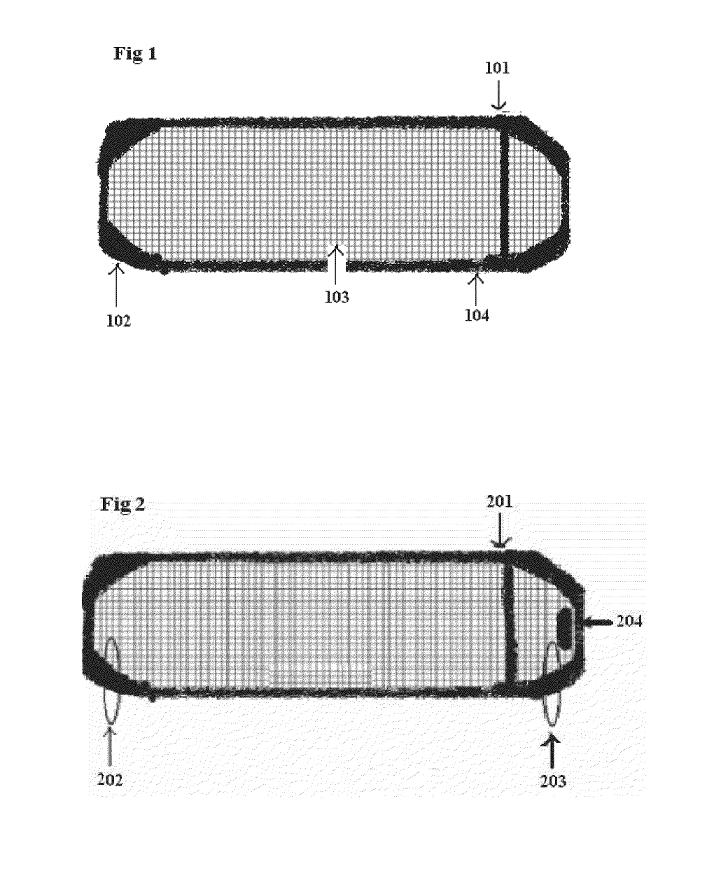

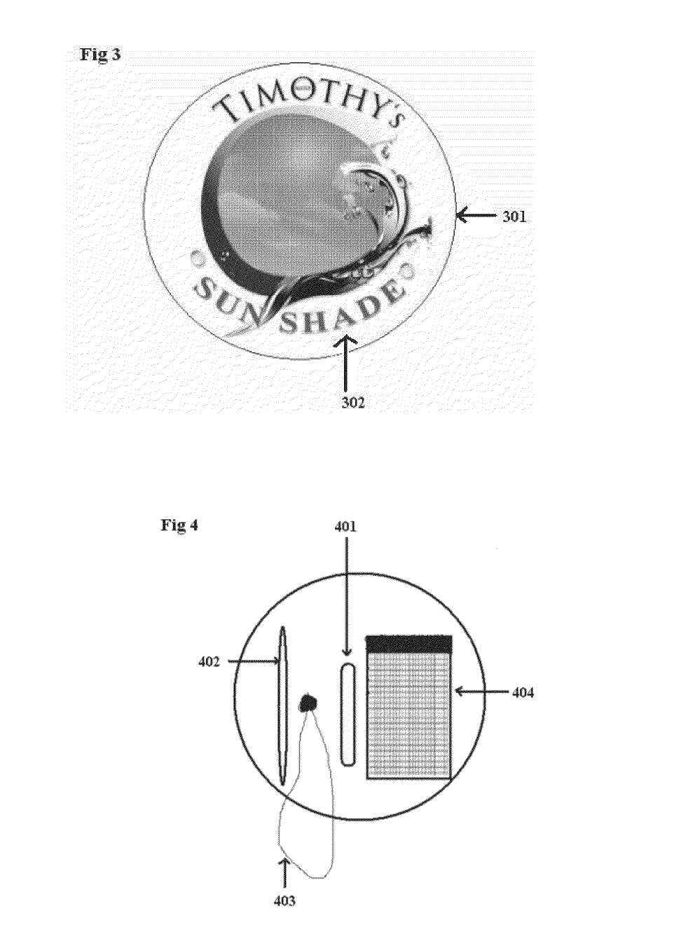

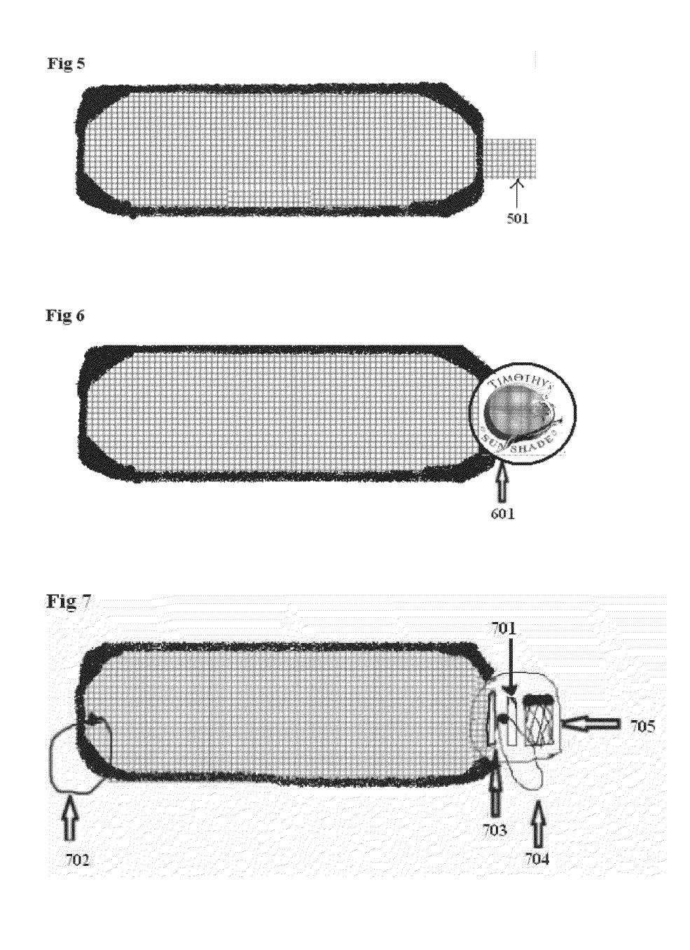

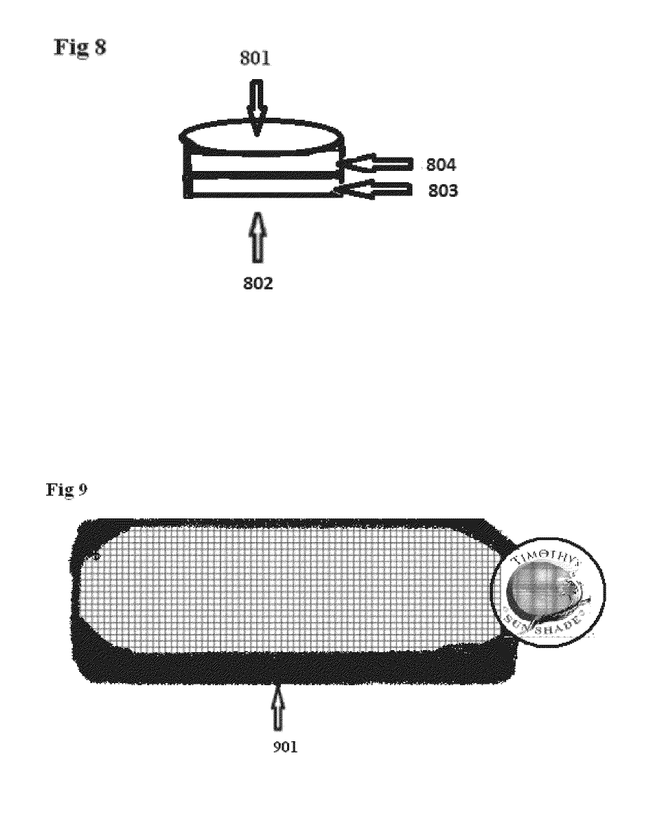

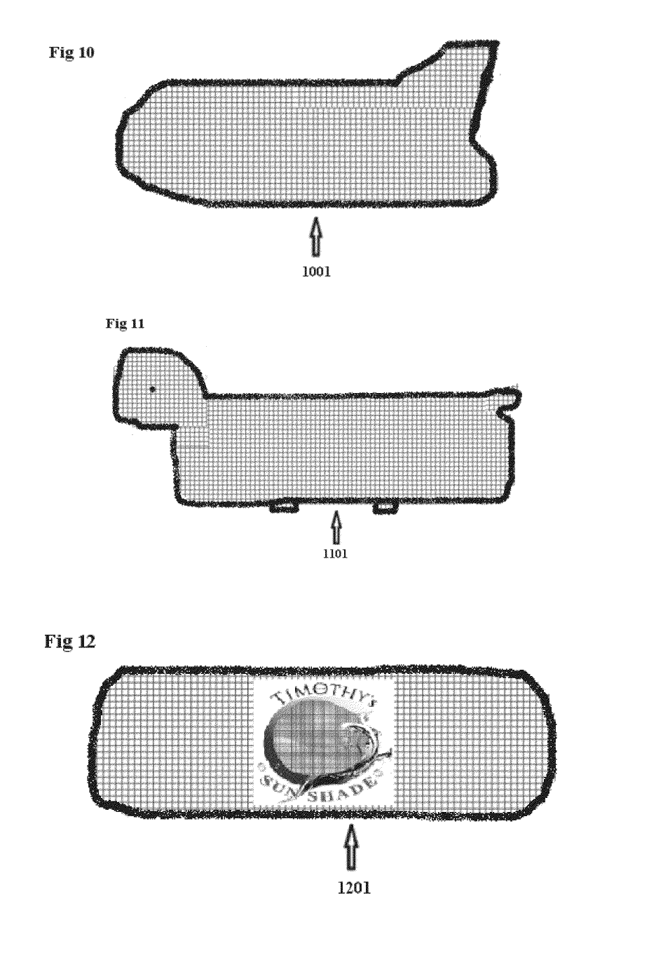

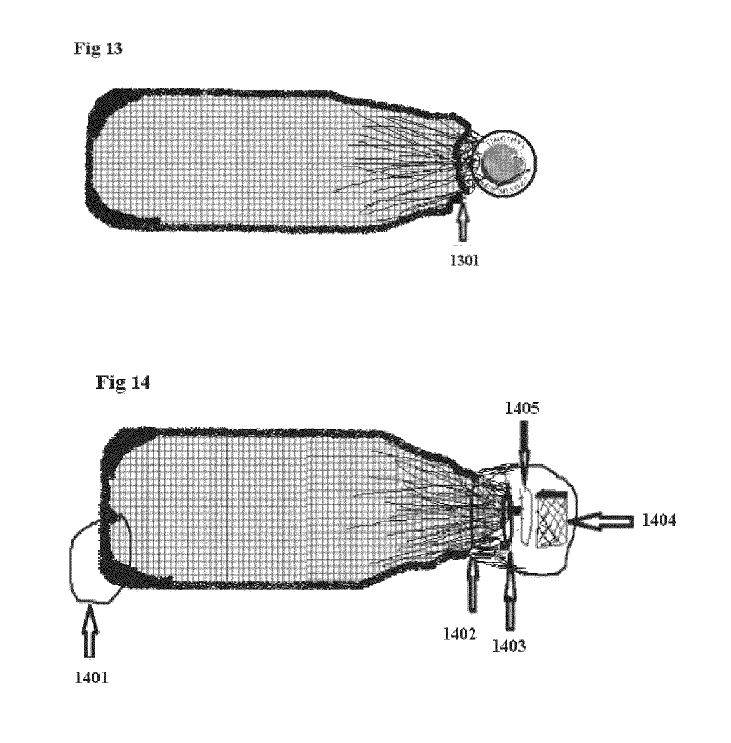

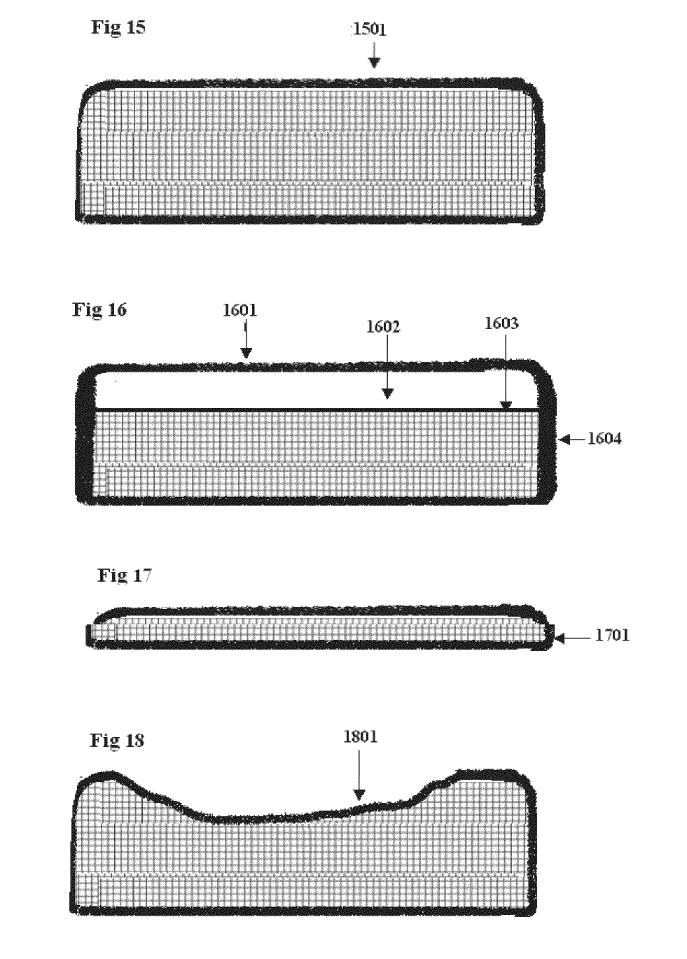

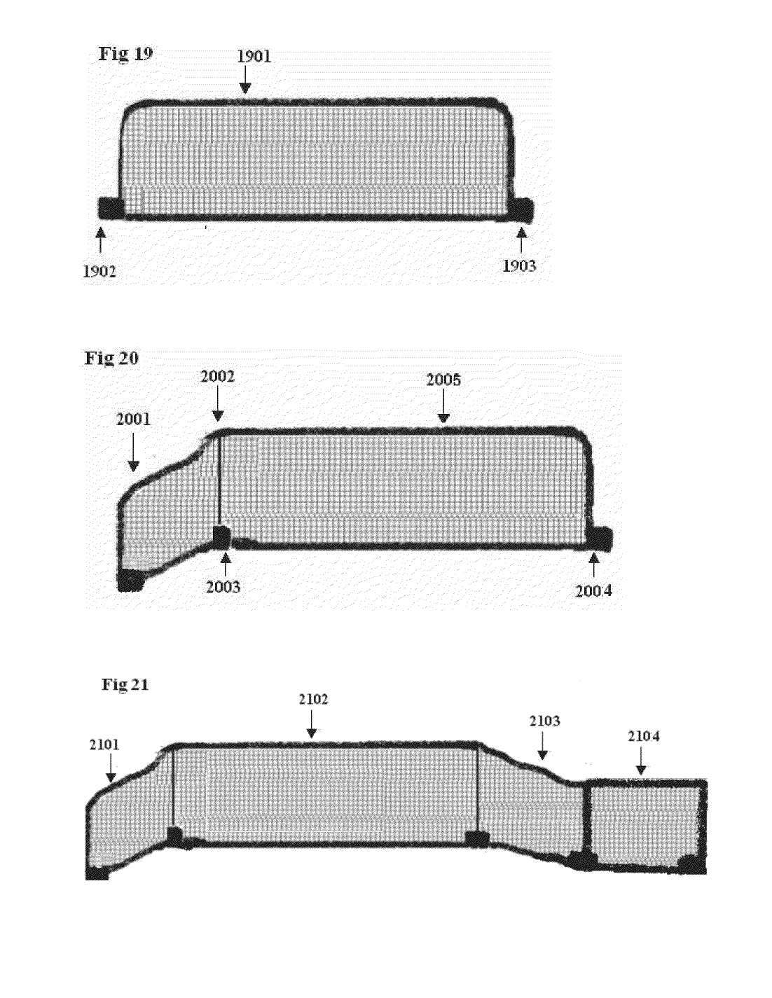

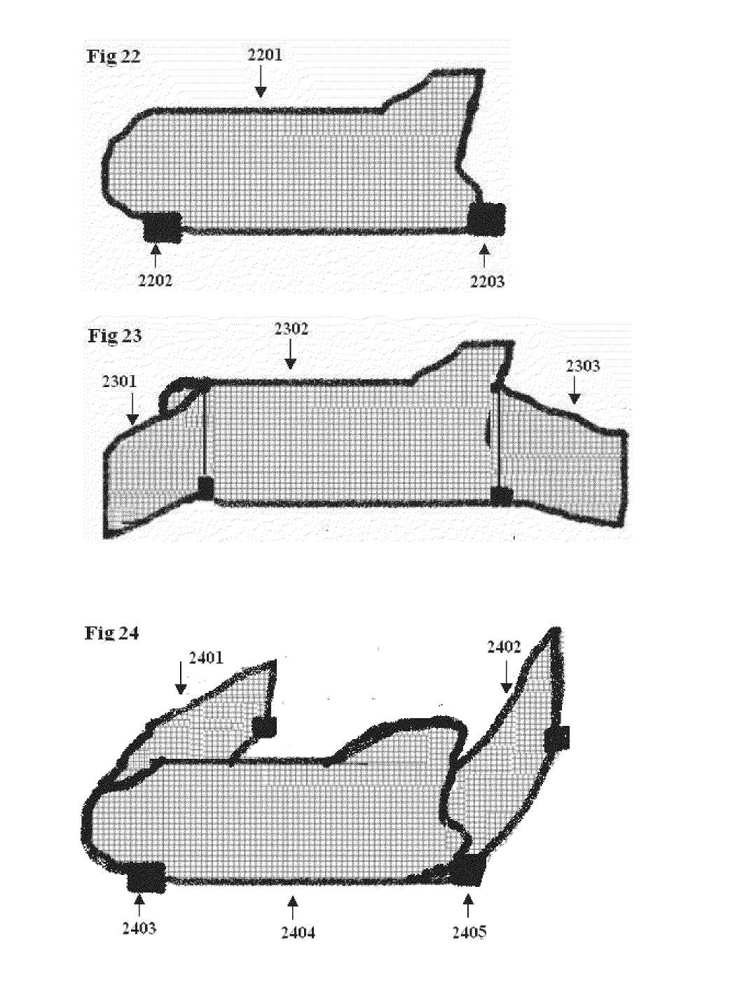

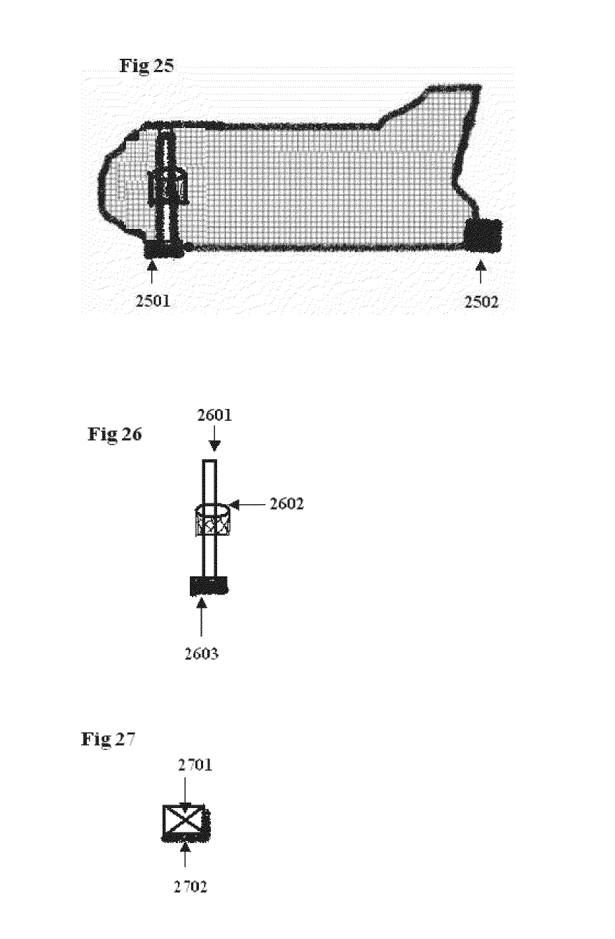

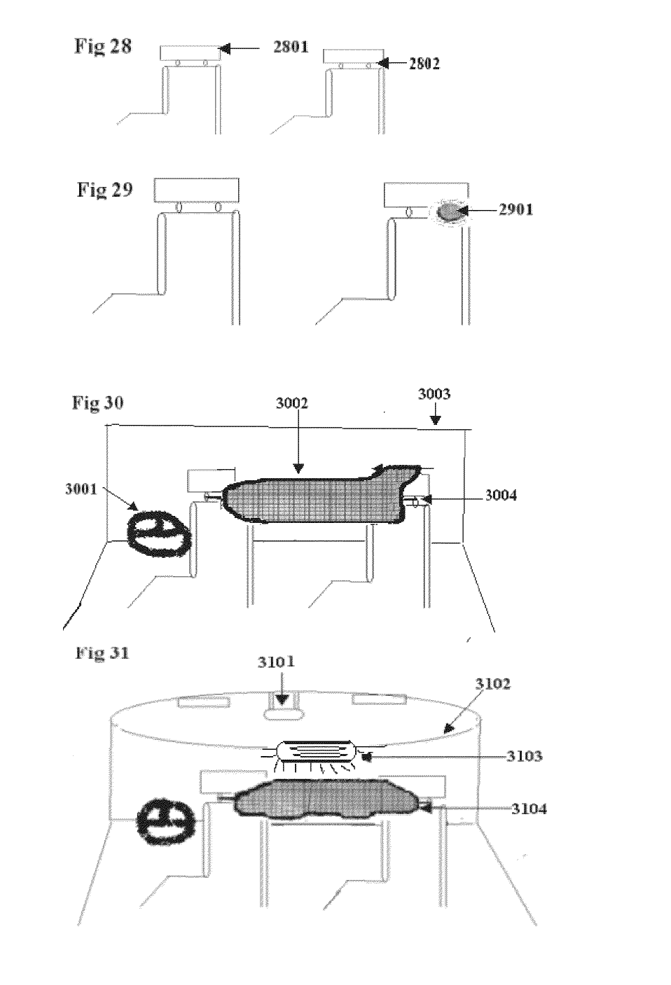

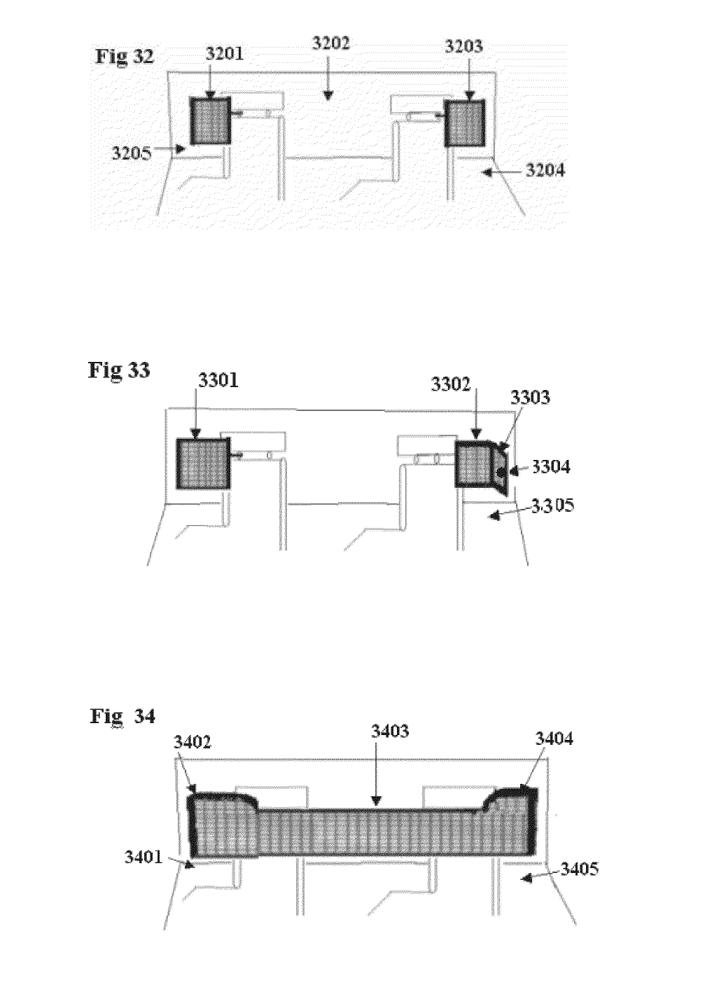

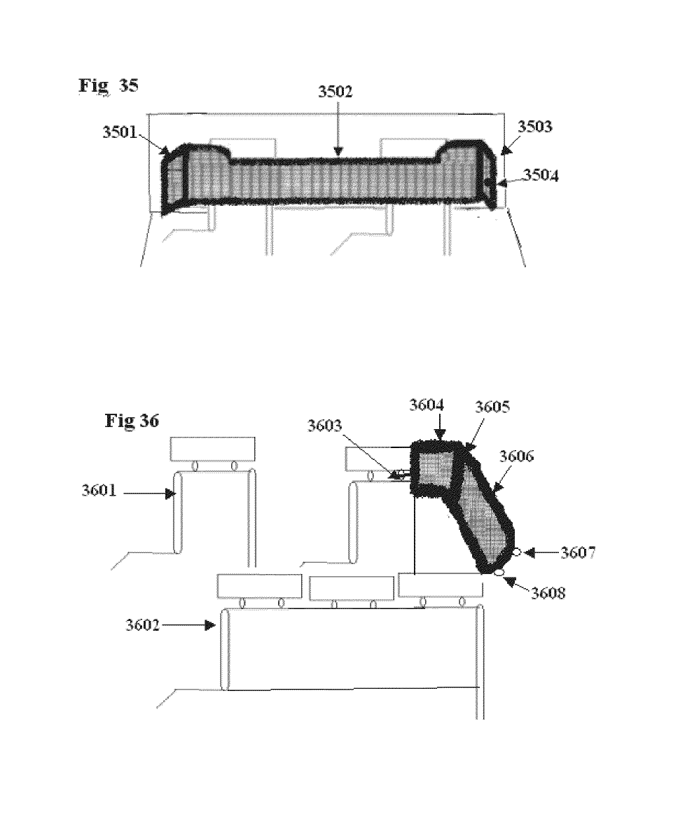

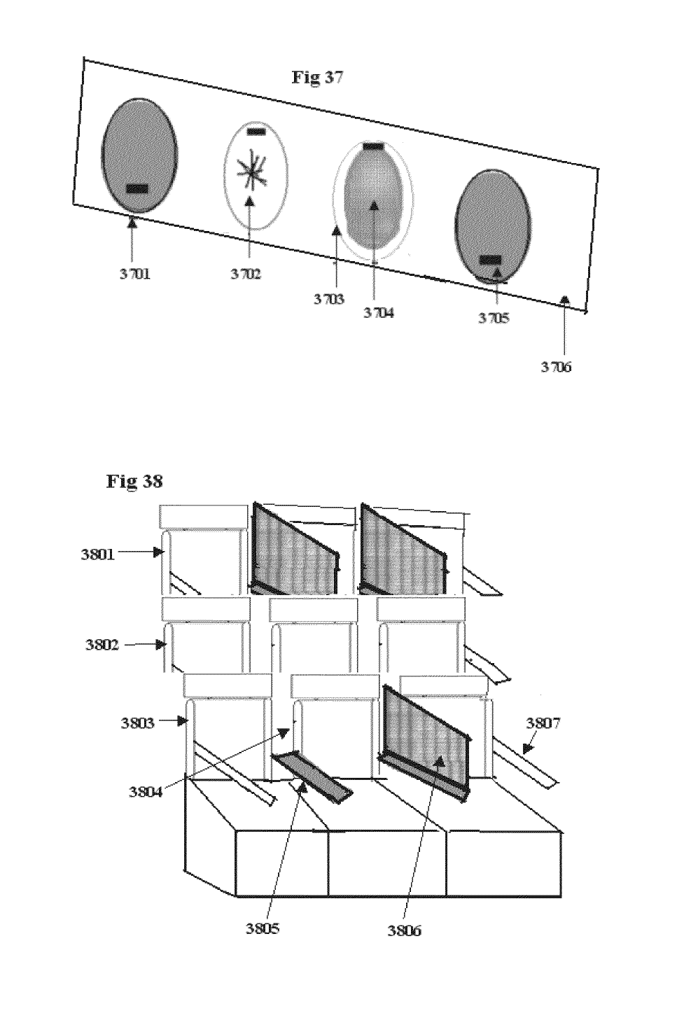

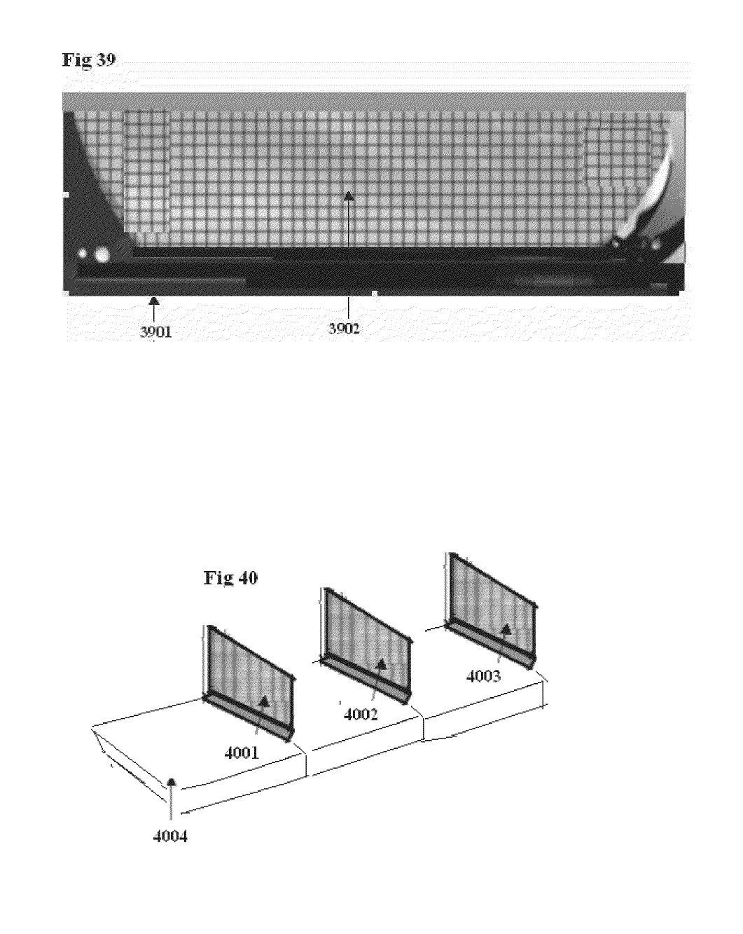

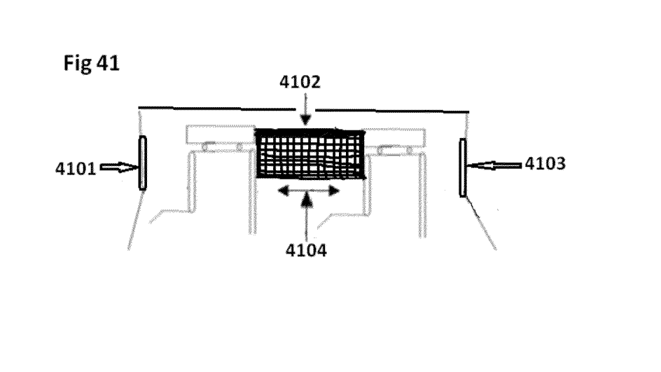

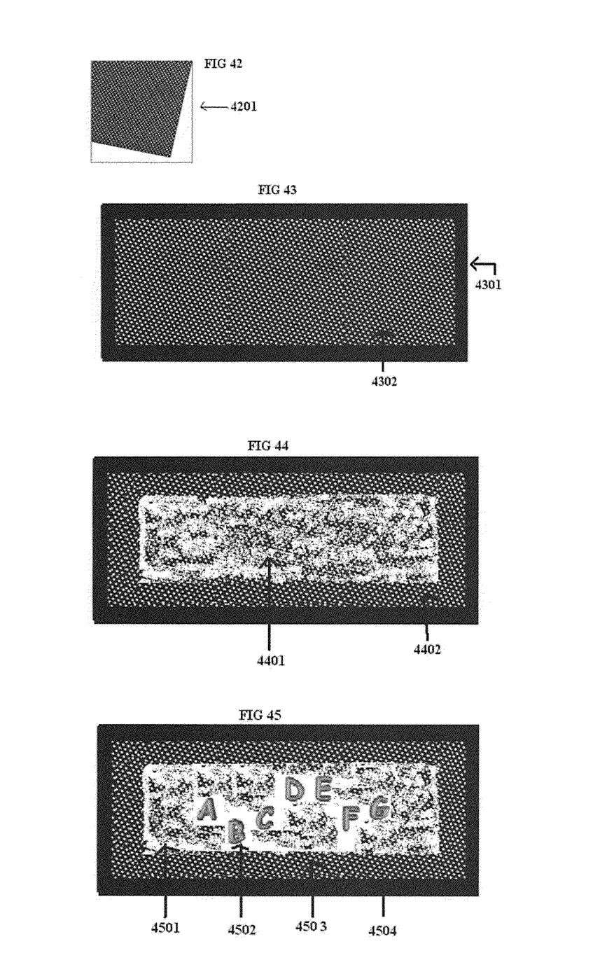

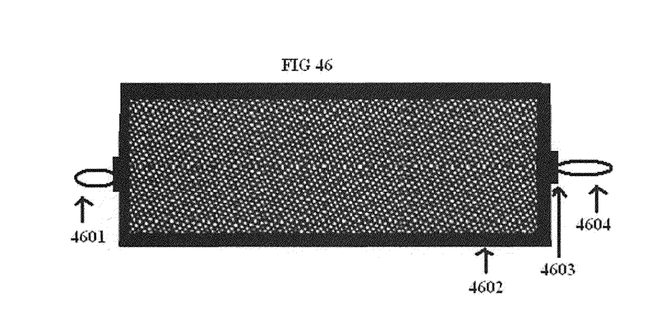

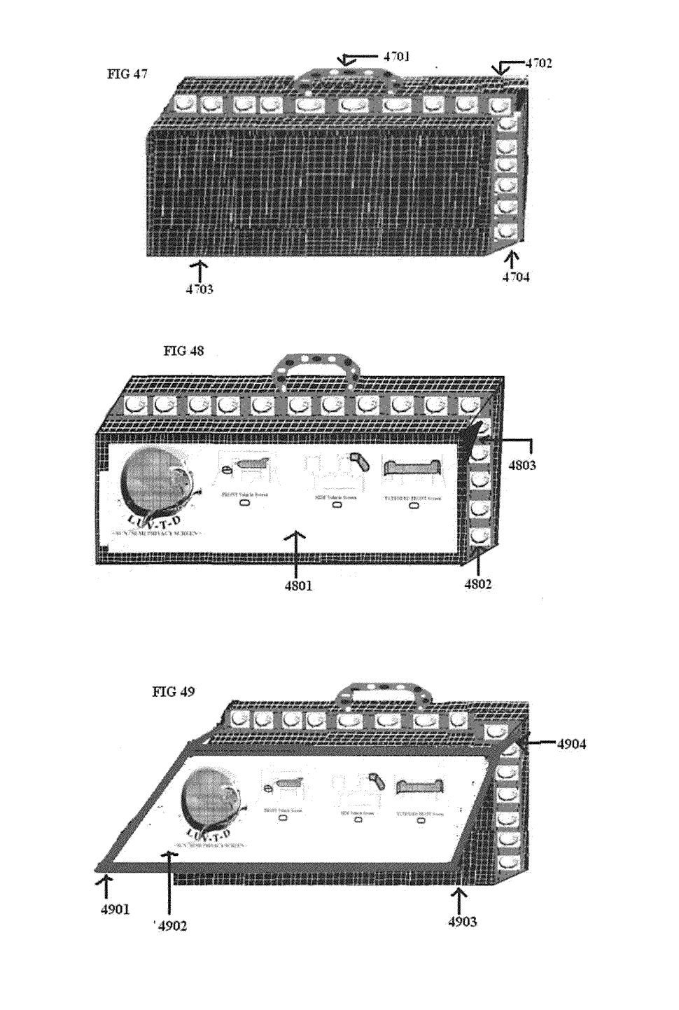

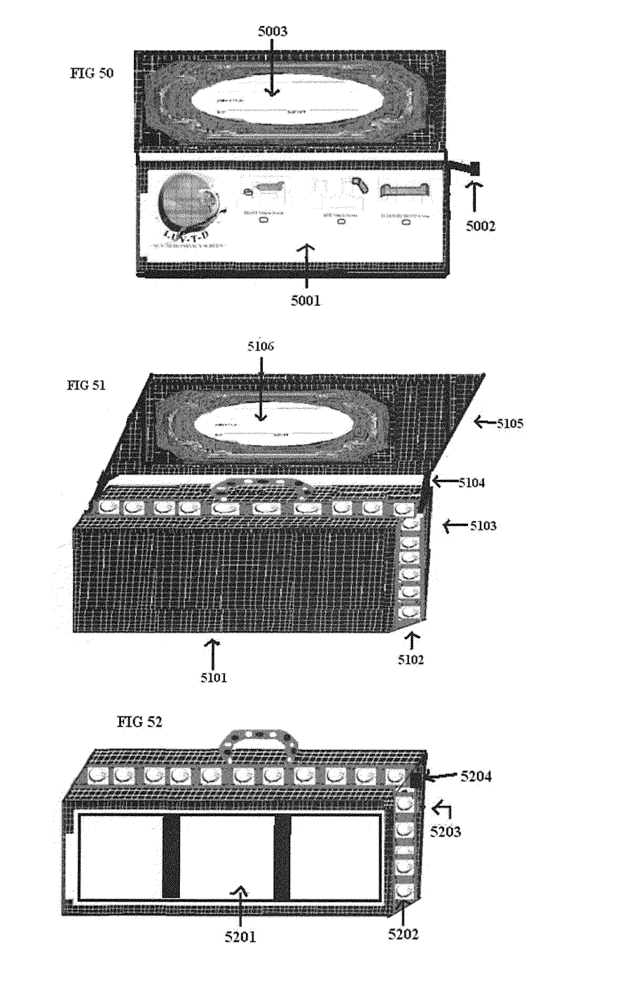

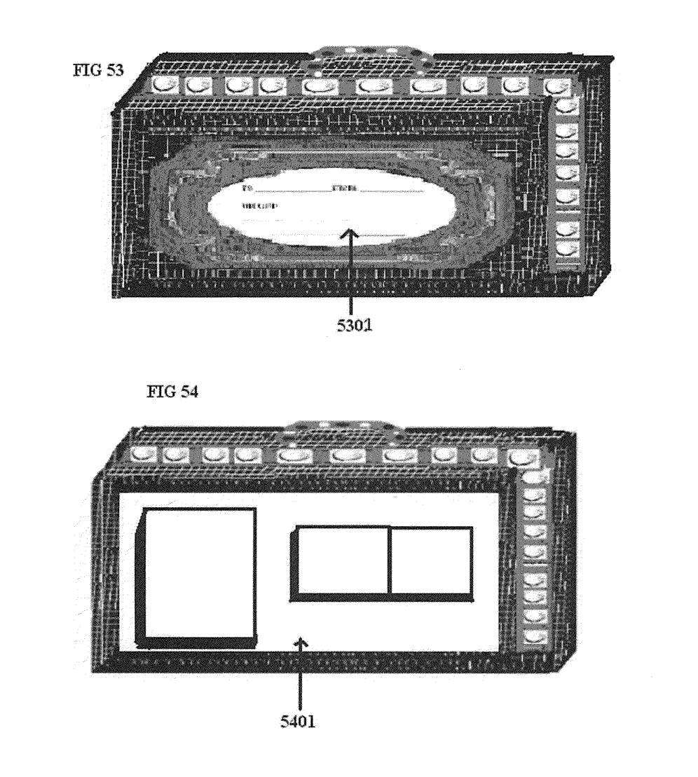

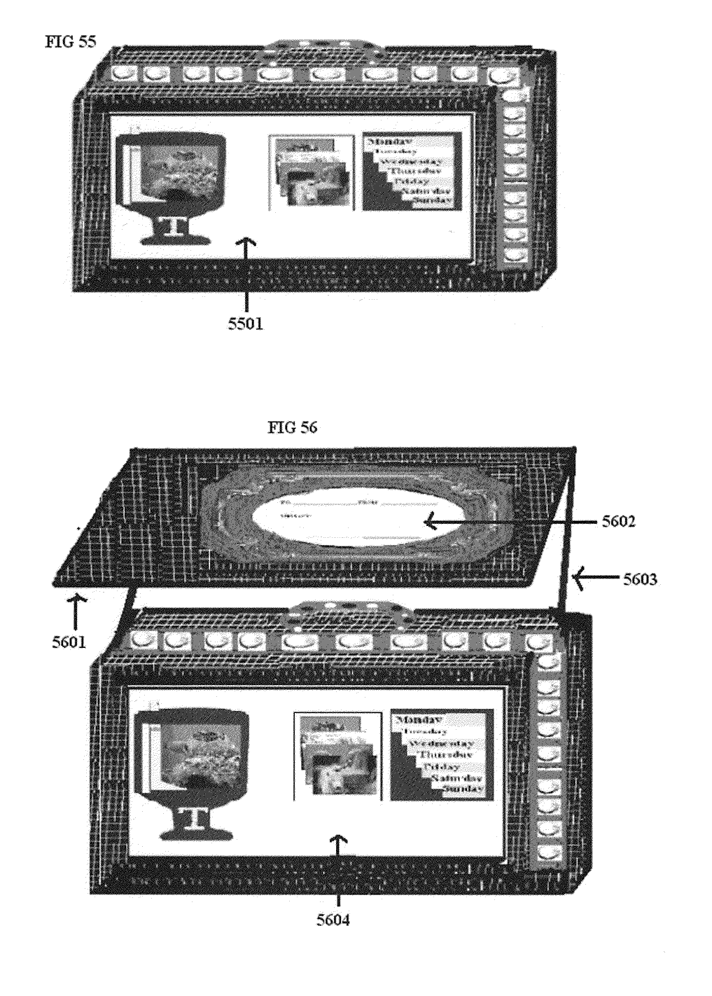

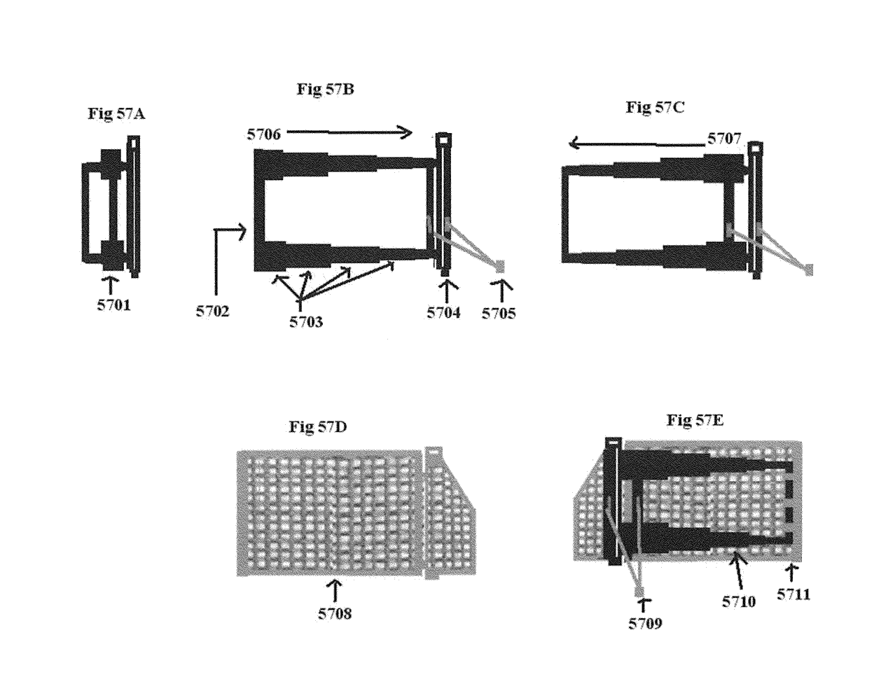

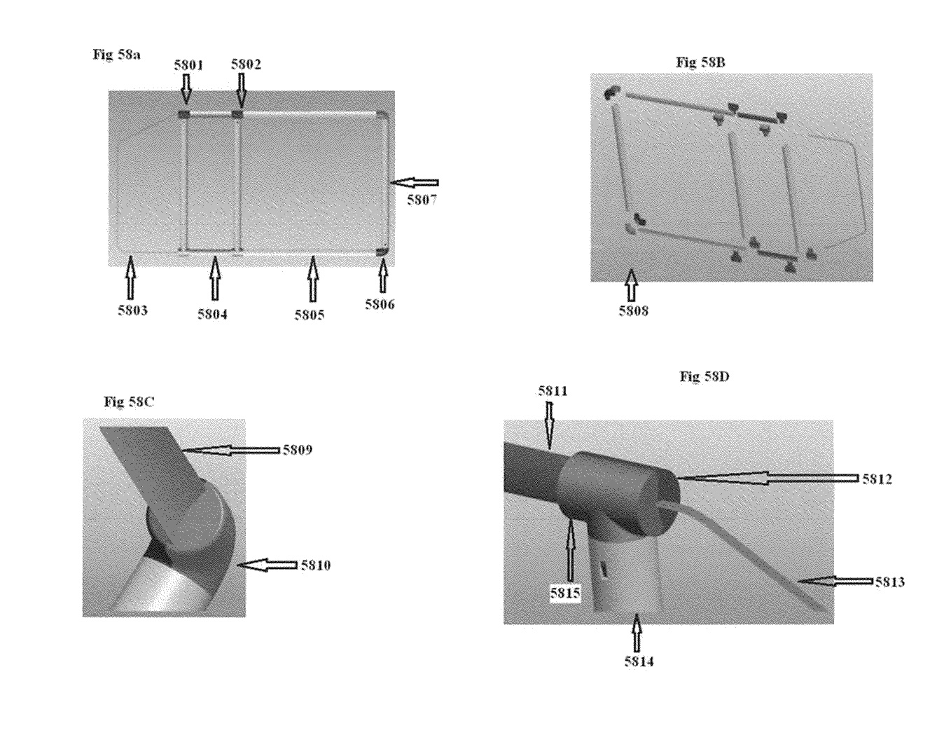

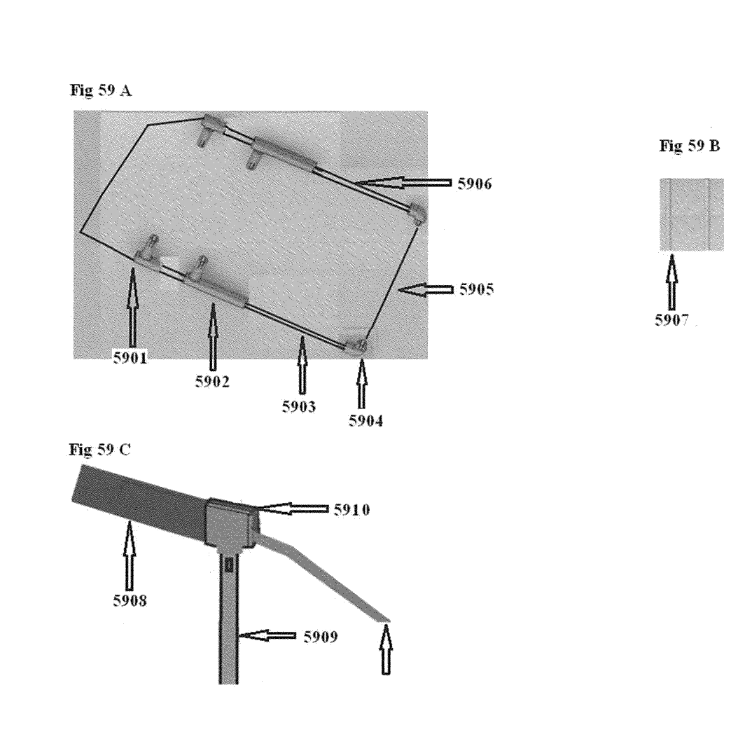

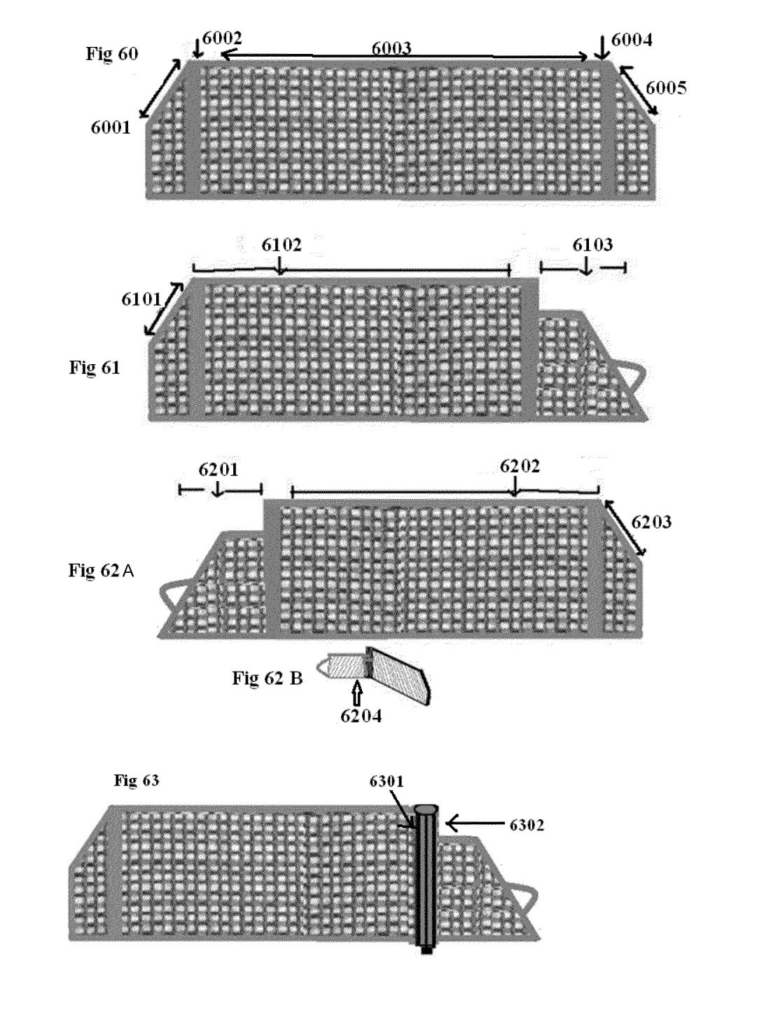

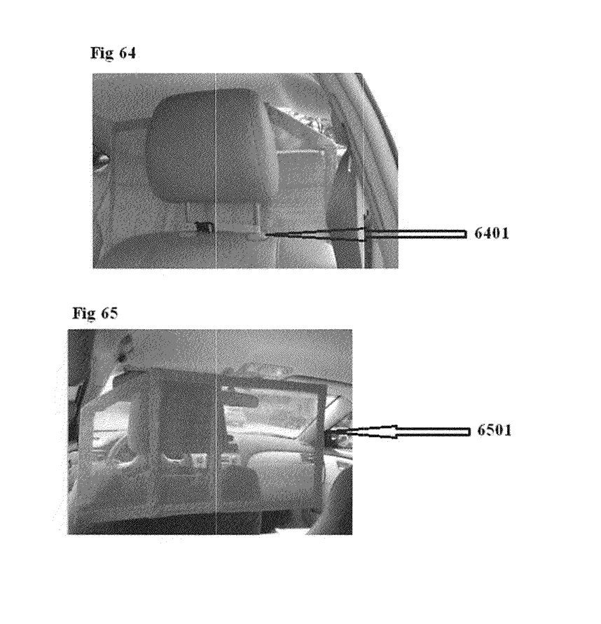

Screen with Front Extended sides for Passenger's and Drivers sides between the doors.
3401 Refer to FIG. 32, 3205
3402 Front Extended ends to cover the Drivers side space between door and seat.
3403 Screen and design shape
3404 Extended ends to cover the Passenger's side space between door and seat
3405 Refer to FIG. 32, 3204

FIG. 35
3501 Extended ends to cover the Drivers side space between door and seat. Extended ends can be folded back and attach to the body of the screen for passenger's and driver's side.
3502 Design and shape of screen
3503 Side Extended end between passenger's door and back window
3504 Suction cup

FIG. 36
3601 Driver's seat
3602 Back Seat passengers
3603 Screen attached to head rest
3604 Ref to FIG. 33, 3202
3605 Support to bend shape to cover both sides
3606 Refer to FIG. 33, 3303 Except this is full size version
3607 1^{st} suction cup
3608 2^{nd} suction cup

FIG. 37

Airplane Window/Boat Window but not limited to, different views and way to cover from the sun. Size and shapes can vary.
3701 Airplane window closed
3702 Sun shining through the window
3703 Outer edge of Screen window
3704 Portable Screen attached on window opening
3705 Handle to close or open window
3706 Structure to hold window

FIG. 38

Airplane seat rows but can also be use in other settings or seating arrangements
3801 Row of seats with 2 dividers for semi privacy
3802 Row of seats with out dividers
3803 Row of seats with 1 divider
3804 Space between 2 seats
3805 Adjustable arm rest
3806 Portable divider attached to arm rest
3807 Isle arm rest

FIG. 39

Screen attached to the window.
3901 Front or back of a vehicle and or airplane wind shield.
3902 Screen attached to wind shield. Sizes and shapes can vary.

FIG. 40

Divider for airplane trays or can be use for other functions in a different setting
4001 Individual Dividers or Semi Privacy screen for each tray table
4002 Refer to 4001
4003 Refer to 4001
4004 Tray Table

FIG. 41

Sun Screen/Divider/Privacy or Semi Privacy screen between Passenger and drive Seat
4101 Attachment to structure of vehicle to house screen. It can be portable or permanent. This holder can be any shape or size and attach or built into any part of the vehicle structure or chairs. This is drawing is for illustration purposes only but not limited where the holder can be or installed.
4102 Screens between driver and passenger seats with temporary or permanent attachment. Can be retractable in any form when not in use manually or electronically.
4103 Refer to FIG. 4101 this can also house a different design screen that extends between the passenger to drivers side structure. This can be optional or to FIG. 4102 screen or additional, manual or electronic.
4104 Space/Width between the seats for the screen.

FIG. 42 Static Cling Sun Screen with Erasable writing material
4201 Prior Art Static Cling

FIG. 43
4301 Add Border to design
4302 Refer to 4201

FIG. 44
4401 New updated Art Erasable surface
4402 Refer to 4201

FIG. 45
4501 Refer to 4401
4502 New Able to personalize any message or educational tool daily
4503 Refer to 4201
4504 Refer to 4301

FIG. 46
4601 Adjustable Passenger Strap attaches to head rest. It can also be removed so screen can convert to use on rear window
4602 Refer to 4301
4603 Fixed Strap so the adjustable strap can slide up or down
4604 Adjustable Driver's Strap attaches to head rest. It can also be removed so screen can convert to use on rear window Refer to 4601

FIG. 47 Product box looking like a gift box from the front
4701 Product handle
4702 Top of Box
4703 Front of Box
4704 Side of box (Can also have ribbon and logo design . . . optional)

FIG. 48
4801 Product information in front of the box (Double side card optional)
4802 Refer to 4704
4803 One of the ways the product box can be converted to gift box. By attaching the side which allows the card to go into either direction.

FIG. 49
4901 Product label is being raised to flip over to convert into a gift box. Gift tag is behind product label
4902 Top side with product label
4903 Plain box design that does not show product image
4904 Refer to 4803

FIG. 50 Double Side label
5001 Product label
5002 Attaches to side to flip front or backwards
5003 Gift Tag label

FIG. 51
5101 Front of box
5102 Refer to 4802
5103 Back of box
5104 Refer to 4803
5105 Other side of label (Refer to 5001)
5106 Refer to 5003

FIG. 52
5201 Back of box and product information
5202 Refer to 4802
5203 Refer to 4801
5204 Refer to 4803

FIG. 53 Box with Gift Tag
5301 Converted product box to gift box

FIG. 54 Different option product box
5401 The empty box with clear top to show product when inside

FIG. 55
5501 Product in box and visible

FIG. 56 Showing how the product box is converted to gift box
5601 Back with product information that was a the back of box
5602 Gift Tag
5603 Refer to 4803
5604 Refer to 5501

FIG. 57 A
5701 Adjustable rod apparatus

This adjust to make the screen small for storage or large when in use

FIG. 57B
5702 Side bar with adjustable segments
5703 Adjustable segments, each piece goes into the other to make device smaller
5704 Button to make screen roll into device
5705 Attachment to secure device when in use for example passenger or driver deat but not limited to
5706 The adjustable device can be made and attached in any direction. This illustration is in one direction and refer to FIG. 57C for other direction

FIG. 57C
5707 Refer to FIG. 57B, 5706 the segment device is in the opposite direction.

FIG. 57D
5708 Sample of one of the vehicle screen design from the back seat passenger view

FIG. 57E (Front seat passenger view)
5709 Device attached to rods to secure screen to the vehicle seat when in use
5710 Rod extended when in use
5711 Other End of the adjustable rod attach to the screen

FIG. 58—-3D drawings of the concept

FIG. 58A
5801 Connectors that attaches different parts to the frame to make 1 unit.
5802 Refer to FIG. 58A, 5801
5803 Apparatus can be any material to make the shap any geometrical shape to complete the frame. Illustration purposes only wire was shown
5804 Flexible material for frame so the device can be bent or roll when not in use and become smaller
5805 Refer to FIG. 58A
5806 Refer to FIG. 58A, 5801
5807 Sturdy apparatus to hold the frame shape. For illustration purposes only plastic tube was used.

FIG. 58B
5808 All pieces shown separate for illustration

FIG. 58C
5809 Flexible material when folded can retract to it's original shape when open
5810 Refer to FIG. 58A 5806

FIG. 58D
5811 Refer to FIG. 58C 5809 this is another angle of the same piece
5812 Refer to FIG. 58A, 5806
5813 Refer to FIG. 58A, 5803 this is a different angle
5814 For illustration purposes only this a plastic rod to hold shape in firm shape

FIG. 59A Similar to FIG. 58A
5901 Connector to make the frame into 1 piece from a few angles
5902 Refer to FIG. 5901
5903 Refer to FIG. 58A, 5805
5904 Refer to FIG. 59A, 5901
5905 Sturdy frame to keep shape for example wire, or plastic rod but not limited to
5906 Refer to FIG. 59A, 5903

FIG. 59B
5907 Refer to FIG. 58A, 5807

FIG. 59C
5908 Refer to FIG. 58D, 5811
5909 Refer to FIG. 58D, 5814
5910 Refer to FIG. 58D, 5812 but this design is flat instead of round
5911 Refer to FIG. 58D, 5813

FIG. 60 Illustration of one of the front car screen design
6001 Coverage between the driver seat and door
6002 Slots to hold rods to keep firm shape when in use
6003 Width of the screen from the driver seat to the passenger seat or any 2 seat locations if vehicle has multiple seats rows.
6004 Slots to hold rods to keep firm shape when in use
6005 Coverage between the passenger seat and door

FIG. 61 Side window screen cover side window and area between driver door and driver seat
6101 Can be made with or with out this section. For illustration it is show for a vehicle with a small side window next to the large side window. 6101 covers the small side window.
6102 Covers the lard part of the sid window behind the driver side
6103 Covers the area between the driver door and driver seat and attaches to the driver head rest.

FIG. 62A
6201 Covers the area between the passenger door and passenger seat and attaches to the passenger head rest
6202 Refer to FIG. 62, 6102
6203 Refer to FIG. 62, 6101

FIG. 62B
6204 Illustration how the spake may look when attached to the back passenger side window and the front passenger head rest.

FIG. 63
6301 Double roll up container apparatus so the screen can be rolled from both angles the same time or separate
6302 Refer to FIG. 63, 6301

FIG. 64
6401 Illustration purposes only sample of screen attached to the driver head rest . . . Front Seat View

FIG. 65
6501 Illustration purposes only sample of screen attached to the driver head rest . . . Back seat view

### DETAILED DESCRIPTION

### Vehicle Sun Screen

### Basic Shape

1. The basic shape of the Sun Screen is rectangle but not limited to.
2. Optional, the 4 corners have a support confirming material for the edge to keep the shape. Material for or in edge can be firm or confirming.
3. Adjustable strap for optional side window usage to change the shape of the screen.
4. Suction cup for optional side window.
5. Velcro or similar material to attach screen to another screen
6. Other Design
   a. The package/housing is attached to Passenger side of the sun screen.
   b. The 2^{nd} adjustable fabric is attached to the driver side of the screen to hold screen in place.

### Deluxe Shapes

The shapes of the screen can be made to look like the below but not limited to:
1. Animals, Vehicles, Characters, Buildings, Fun Shapes and objects
2. Folding option for ends to the body of screen if all the pieces are not in use

### Optional Graphic on or Around Shade Border

1. Different graphic design can be made on the screen mess including logos, license designs, other graphic designs. Lights, (glow in the dark material as optional privacy screen)

### Material for Sun Shade

1. Mesh material used to block the sun.
2. The 4 Edge has a flexible and confirming material to hold it in shape to keep it's rectangular shape.
3. Static cling Updated art with erasable surface
4. Incorporate solar technology into sun screen mesh to capture power supply
5. Prongs and inverters will be need for the solar mesh to release power supply

### Portable Semi Privacy Screen Description

1. This can be used in a vehicle, work place, school and other locations
2. It is can be confirmed in to several shapes and lengths
6. Designs can be basic or shapes of Vehicles or Animals
7. The Deluxe and Basic shapes can be mixed and match.
8. Offer semi privacy and space separation at a reasonable cost
9. Optional accessories holder to clear clutter from work/play space
10. Portable, light weight and easy storage

### Material for Portable Semi Privacy Screen/Dividers

1. Material can be opaque or mesh defending on the use for vehicle or other
2. The side edges and top can be made with Velcro or other adjustable material.
3. Velcro or other adjustable material at the sides will connect more than 1 screen together.

### Airplane Shades, Dividers, Semi Privacy Portable Screens

The screen can be made of Sun Screen material or other material depending on the purpose, use and function. The shapes and designs can vary according to standard options or customized options. The screen can be used to block sun, used for semi privacy, dividers but not limited to.

### Package

### Package Description Usage

1. The Sun Screen will be stored in the package when it is not in use to be hidden from view.
2. Optional Air Freshener with kids scents can be stored in the back pocket designed.
3. Adjustable strap can be use for attaching the package to the passenger side head rest
4. Suction cup for optional side window use.
5. 1^{st} inside layer for screen
6. 2^{nd} layer for additional storage to include converters etc

### Design and Material for the Package

1. The Package is designed using the Company logo on the front.
2. The package is designed to keep the sun screen hidden from view when not in use.
3. The package material can be made of fabric.
4. The pocket for storing the optional air freshener can be made from the sun screen mesh with a secure fasten fabric cover.
5. The suction cup can be oblong or round to attach to the side window.
6. The Strap to attach to the passenger seat head rest is adjustable fabric.
7. 1^{st} lay is for screen storage
8. 2^{nd} layer is for other storage including but not limited to lights or sound converters.

### Front of Package

1. The company logo is used as the front cover for the package design
2. Visual product design or opaque image design
3. Converts to Gift box with tag

### Back of Package

1. The back of the package is a plain material.
2. It has a slit for the screen to be placed inside when it is no longer in use so the screen can be hidden from view.
3. There is an adjustable rectangle material to connect the package to the Passenger car seat head rest.
4. There is a suction cup attached to the package. This can be used to connect the Sun Shade to the back side window.
5. Other package material will be sturdy material including card board, fabric box but not limited to.
6. Box can have additional product information behind.
7. Depending on the product the back of the box can convert into gift tag or any other design.

Black Light Bulb Substitution in Over Head or Side Doors Fixture to Produce Black Light in Vehicle. (Detail Description)
1. The bulb need to be made in different sizes to fit all standard sizes for each major vehicle design.
2. It should produce the black light with little energy to be efficient.
3. Ideally the bulb will be make with an adaptor/converter at the end to adjust and fit most vehicle over head or side door light compartment.
4. Optional dim on the bulb adaptor/converter
5. The bulbs should be in several watts.

It is therefore contemplated that the instant disclosure will embrace any such alternatives, modifications and variations as falling within the true scope and spirit of the present invention.

In so far as the description above and the accompanying drawing disclose any additional subject matter that is not within the scope of the limited claims below, the inventions are not dedicated to the public and the right to file one or more applications to claim such additional inventions is reserved.

It should be recognized that the scope of this invention is much broader than presented by the appended claim herein. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

What is claimed is:

1. An apparatus for screening the sun from the occupants of a vehicle, said apparatus comprising:
A mesh material to block a portion of the incident solar rays from entering the passenger compartment of the vehicle,
Said mesh material being sufficiently flexible to conform to any vehicle window shape, yet sufficiently firm to retain its solar ray blocking abilities,
Said mesh material having a coating places thereon giving said mesh material the ability to have an erasable message written thereon.

2. The apparatus of claim 1, wherein said mesh material also has solar photo-voltaic capable materials affixed thereon for additional portable electrical power supply.

3. The apparatus of claim 1, wherein said apparatus is used as an in vehicle work station divider.

4. The apparatus of claim 1, wherein said apparatus is used as a privacy screen for passengers in aircraft.

5. The apparatus of claim 1, wherein said mesh material is capable of having electroluminescent materials added thereto for in vehicle passenger entertainment and education.

6. A method for screening the sun from the occupants of a vehicle, said method comprising:
Having a mesh material to block a portion of the incident solar rays from entering the passenger compartment of the vehicle,
Said mesh material being sufficiently flexible to conform to any vehicle window shape, yet sufficiently firm to retain its solar ray blocking abilities,
Said mesh material having a coating places thereon giving said mesh material the ability to have an erasable message written thereon.

7. The method of claim 6, wherein said mesh material also having solar photo-voltaic capable materials affixed thereon for additional portable electrical power supply.

8. The method of claim 6, wherein said method is used as an in vehicle work station divider.

9. The method of claim 6, wherein said method is used as a privacy screen for passengers in aircraft.

10. The method of claim 6, wherein said mesh material being capable of having electroluminescent materials added thereto for in vehicle passenger entertainment and education.

11. An system for screening the sun from the occupants of a vehicle, said system comprising:
A mesh material to block a portion of the incident solar rays from entering the passenger compartment of the vehicle,
Said mesh material being sufficiently flexible to conform to any vehicle window shape, yet sufficiently firm to retain its solar ray blocking abilities,
Said mesh material having a coating places thereon giving said mesh material the ability to have an erasable message written thereon.

12. The system of claim 11, wherein said mesh material also has solar photo-voltaic capable materials affixed thereon for additional portable electrical power supply.

13. The system of claim 11, wherein said system is used as an in vehicle work station divider.

14. The system of claim 11, wherein said system is used as a privacy screen for passengers in aircraft.

15. The system of claim 11, wherein said mesh material is capable of having electroluminescent materials added thereto for in vehicle passenger entertainment and education
